(19) United States
(12) Patent Application Publication
(10) Pub. No.: US 2019/0375618 A1
(43) Pub. Date: Dec. 12, 2019

(54) CUTTER FOR ROPES AND TAPES

(71) Applicant: Industro International Co., Ltd., Taichung City (TW)

(72) Inventor: Kuo-Chan Huang, Taichung City (TW)

(21) Appl. No.: 16/001,897

(22) Filed: Jun. 6, 2018

(51) Int. Cl. B66F 15/00; B25F 1/00; B25G 1/06

(52) U.S. Cl. CPC B66F 15/00; B25G 1/06; B25F 1/006

(57) ABSTRACT

A crowbar includes a handle, a blade and a reinforcement element. The handle includes a restraining portion. The blade extends from an end of the handle at an angle. The guiding and supporting portion extends from the primary blade at an angle and includes a tip connected to the restraining portion of the handle, thereby keeping the handle at a constant angle measured from the primary blade.

### BACKGROUND OF INVENTION

### 1. Field of Invention

The present invention relates to templates and, more particularly, to a crowbar used to remove templates.

### 2. Related Prior Art

U.S. Pat. No. D567052 discloses a pry bar that includes a handle connected to a blade. The blade extends substantially perpendicular to the handle. The blade includes an edge that can be forced into a gap between two templates. Then, the handle can be pressed toward a wall or pivoted about an axis in perpendicular to the wall to detach the templates from the wall.

U.S. Pat. No. 8,365,378 discloses a molding removal tool assembly that includes a handle 12, a plate 24 connected to the handle 12, and a tab 46 formed on the plate 24. The plate 24 includes an edge 34. A tab 44 extends from the plate 24, away from the free lateral edge 34 of the plate 24. The tab 44 is used as a wedge to facilitate detachment of a template from a wall. However, both of the plate 24 and the tab 44 are vulnerable to deformation, thereby rendering the molding removal tool assembly inefficient.

The present invention is therefore intended to obviate or at least alleviate the problems encountered in prior art.

### SUMMARY OF INVENTION

It is the primary objective of the present invention to provide a reliable, effective and efficient crowbar.

To achieve the foregoing objective, the crowbar includes a handle, a blade and a reinforcement element. The handle includes a restraining portion. The blade extends from an end of the handle at an angle. The guiding and supporting portion extends from the primary blade at an angle and includes a tip connected to the restraining portion of the handle, thereby keeping the handle at a constant angle measured from the primary blade.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a crowbar according to the preferred embodiment of the present invention;

FIG. 2 is another perspective view of the crowbar shown in FIG. 1;

FIG. 3 is a rear view of the crowbar shown in FIG. 1;

FIG. 4 is a top view of the crowbar shown in FIG. 1; and

FIG. 5 is a cross-sectional view of the crowbar shown in FIG. 1.

### DETAILED DESCRIPTION OF PREFERRED EMBODIMENT

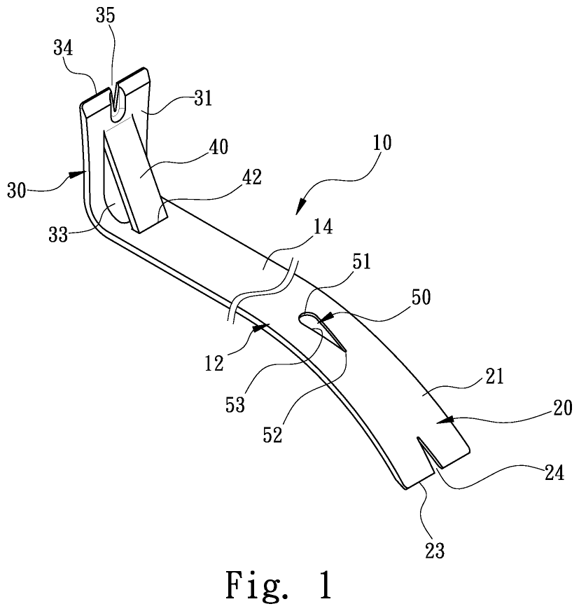

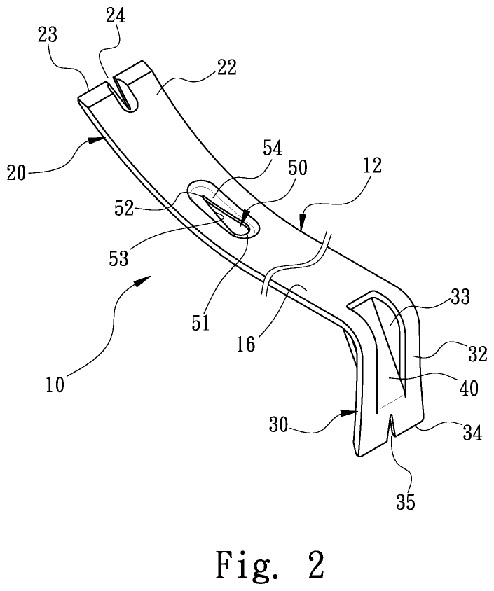

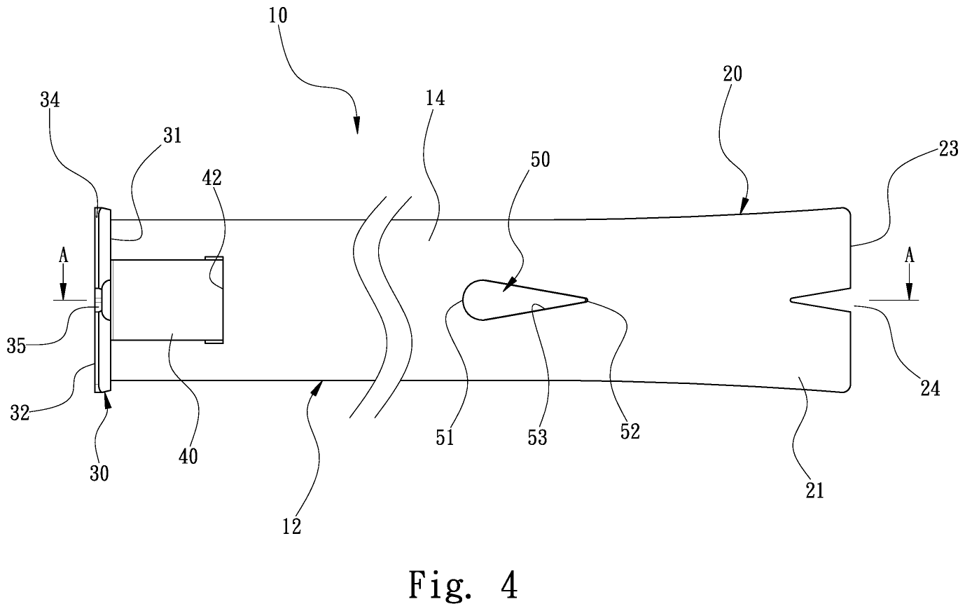

Referring to FIGS. 1 to 5, a crowbar 10 includes a handle 12 formed between two blades 20 and 30 according to the preferred embodiment of the present invention. The crowbar 10 is preferably made of a metal strip. The handle 12 and the blades 20 and 30 are made in one piece. The crowbar 10 includes two blades 20 and 30 in the preferred embodiment. However, the crowbar 10 can include only one blade in another embodiment.

The handle 12 includes two lateral edges (not numbered) formed between two faces 14 and 16. The lateral edges of the handle 12 extend parallel to each other, thereby providing the handle 12 with a constant width 18. The width 18 is preferably 41 mm±5 mm. The faces 14 and 16 extend parallel to each other, thereby providing the handle 12 with a constant thickness T.

The blade 20 includes two lateral edges (not numbered), two faces 21 and 22 and a sharp edge 23. The lateral edges of the blade 20 extend between the faces 21 and 22. The sharp edge 23 is formed at a free end of the blade 20.

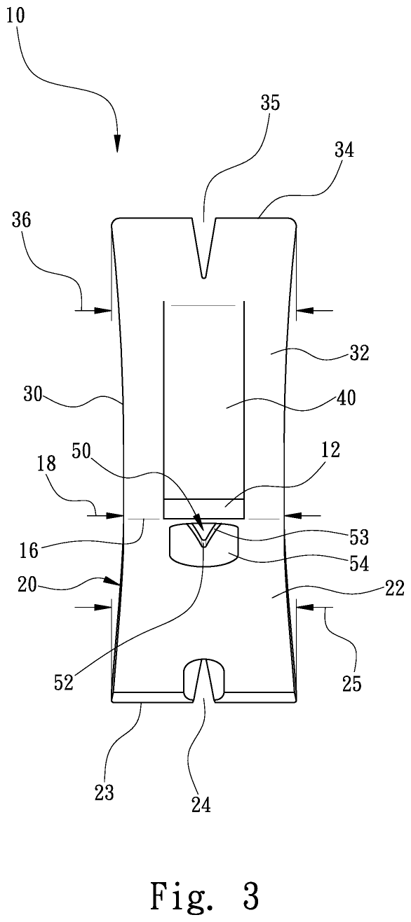

The lateral edges of the blade 20 extend away from each other as they extend toward the sharp edge 23 so that the blade 20 is made with a width that gets larger toward the sharp edge 23. Hence, the sharp edge 23 is made with a width 25 larger than the width 18 of the handle 12 (FIG. 3). The width 25 of the sharp edge 23 is 45 mm±5 mm.

The faces 21 and 22 extend parallel to each other. Thus, the blade 20 is made with a constant thickness identical to that of the handle 12. The face 21 is a convex face that extends from the face 14. The face 22 is a concave face that extends from the face 16.

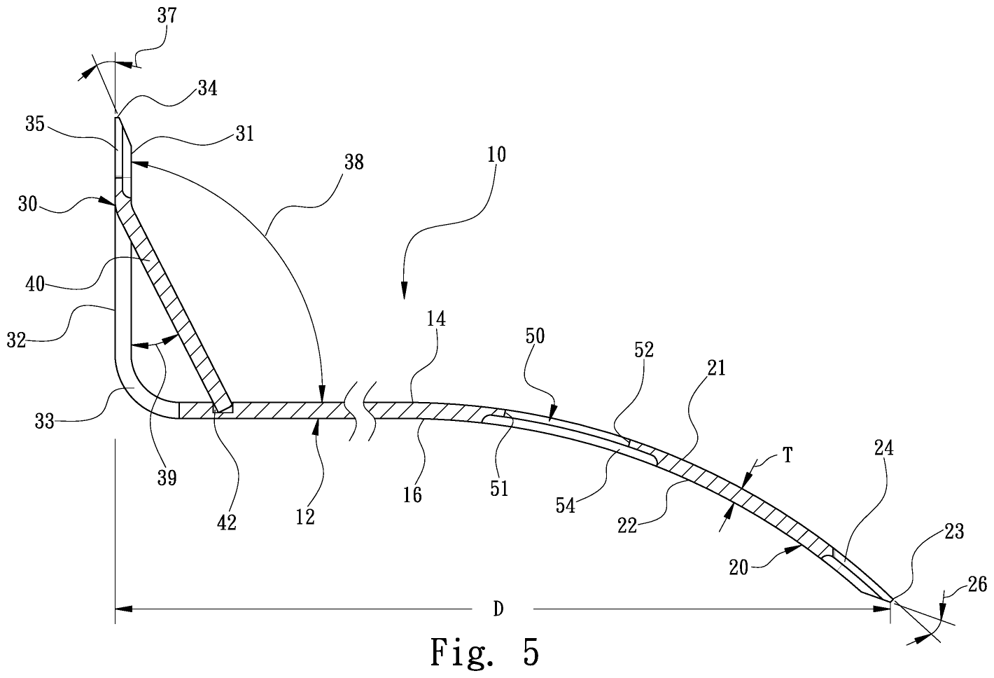

The sharp edge 23 is made by two faces extending at an angle 26 of 16°±5° relative to each other (FIG. 5). The sharp edge 23 is made with a V-shaped notch 24 that gets tapered toward the handle 12.

The blade 30 includes two lateral edges (not numbered), two faces 31 and 32 and a sharp edge 34. The lateral edges of the blade 30 extend between the faces 31 and 32. The sharp edge 34 is formed at a free end of the blade 30.

The lateral edges of the blade 30 extend away from each other as they extend toward the sharp edge 34 so that the blade 30 is made with a width that gets larger toward the sharp edge 34. Hence, the sharp edge 34 is made with a width 36 larger than the width 18 of the handle 12 (FIG. 3). Preferably, the width 36 of the sharp edge 34 is 45 mm±5 mm.

The faces 31 and 32 extend parallel to each other. Thus, the blade 30 is made with a constant thickness identical to that of the handle 12. The face 31 extends from the face 14. The face 32 extends from the face 16.

The sharp edge 34 is made by two faces extending at an angle 37 of 16°±5° relative to each other (FIG. 5). The sharp edge 34 is made with a V-shaped notch 35.

Referring to FIG. 5, the blade 30 extends at an angle 38 of 88°±5° relative to the handle 12. Hence, the handle 12 extends substantially horizontally when the blade 30 extends vertically. As mentioned above, the face 21 is a convex face and the face 22 is a concave face so that the sharp edge 23 is located lower than the handle 12 when the blade 30 extends vertically. The maximum distance D of the sharp edge 23 measured from the blade 30 is 320 mm±5 mm.

Moreover, the blade 30 is made with an opening 33 and a guiding and supporting portion 40 in the vicinity of the opening 33. The guiding and supporting portion 40 is made with a length of 52 mm±5 mm and a width of 20 mm±5 mm. The guiding and supporting portion 40 is made by punching the blade 30 with the opening 33 and bending a portion of the blade 30 within the opening 33. There is an angle 39 of 30°±5° between the guiding and supporting portion 40 and the blade 30. Hence, the guiding and supporting portion 40 includes a root (not numbered) made in one piece with the blade 30 and a tip (not numbered) extending toward the handle 12. The tip of the guiding and supporting portion 40 is connected to the restraining portion 42 made in or on the handle 12. Preferably, the restraining portion 42 is a groove for receiving the guiding and supporting portion 40.

The crowbar 10 further includes a detaching portion 50 on or in a connective portion between the handle 12 and the blade 20. The detaching portion 50 is an aperture made throughout the thickness of the crowbar 10. The detaching portion 50 includes two lateral edges 53 between a round end 51 and a pointed end 52. The round end 51 is located closer to the connective portion between the handle 12 and the blade 20 than the pointed end 52. That is, the pointed end 52 is located closer to the sharp edge 23 of the blade 20 than the round end 51. The detaching portion 50 is preferably a countersink hole, thereby providing a thickness-reduced portion 54 therein. The thickness-reduced portion 54 is located closer to the face 21 than the face 22.

The crowbar 10 can be used to detach various objects from other objects. For instance, the crowbar 10 can be used to remove a nail (not shown) from a piece of wood (not shown). In such case, a portion of the nail near an enlarged head of the nail is inserted in the notch 24 of the blade 20 or the notch 35 of the blade 30. The head of the nail is engaged with the blade 20 or 30 when the handle 12 is pivoted. Thus, the nail is removed from the piece of wood.

Alternatively, the head of the nail can be moved through the round end 51 of the detaching portion 50. Then, the portion of the nail near the head of the nail is moved to the pointed end 52 of the detaching portion 50. The head of the nail is engaged with the thickness-reduced portion 54 as the handle 12 is pivoted. Thus, the nail is removed from the piece of wood.

The crowbar 10 can be used to remove a template (not shown) from a wall (not shown) for example. In such case, the sharp edge 34 of the blade 30 is forced into a gap between the template and the wall, with the face 32 of the blade 30 located against the wall. A hammer (not shown) is used to hit the handle 12 to insert the sharp edge 34 of the blade 30 deeper into the gap between the template and the wall. The guiding and supporting portion 40 is used as a wedge for guiding the template away from the wall. Moreover, the guiding and supporting portion 40 retains the blade 30 in position relative to the handle 12 when the handle 12 is hit by the hammer.

Alternatively, the sharp edge 23 of the blade 20 is inserted in the gap between the template and the wall. The handle 12 is pivoted, with the face 22 used as a fulcrum. Thus, the template is removed from the wall.

The crowbar 10 can be used to remove a ceiling trim or a skirting board from the wall. However, details of such operations will not be described in detail for being similar to the above-discussed operations of removing the template from the wall.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A crowbar comprising:
a handle (12) comprising a restraining portion (42);
a primary blade (30) extending from an end of the handle (12) at an angle; and
a guiding and supporting portion (40) extending from the primary blade (30) at an angle and comprising a tip connected to the restraining portion (42) of the handle (12), thereby keeping the handle (12) at a constant angle (38) measured from the primary blade (30).

2. The crowbar according to claim 1, wherein the restraining portion (42) is a groove made in the handle (12).

3. The crowbar according to claim 2, wherein the guiding and supporting portion (40) is made with a length of 52±5 mm and a width of 20±5 mm, wherein the reinforcement element (40) comprises a root made in one piece with the primary blade (30) and a tip inserted in the restraining portion (42).

4. The crowbar according to claim 1, wherein the guiding and supporting portion (40) extends at an angle (39) of 30°±5° measured from the primary blade (30).

5. The crowbar according to claim 1, wherein the primary blade (30) is at an angle (38) of 88°±5° measured from the handle (12).

6. The crowbar according to claim 1, wherein the guiding and supporting portion (40) is made by cutting an opening (33) in the primary blade (30).

7. The crowbar according to claim 6, wherein the primary blade (30) comprises a sharp edge (34) made by two faces that are at an angle of 16°±5° measured from each other.

8. The crowbar according to claim 6, wherein the sharp edge (34) is made of a width (36) of 45±5 mm, and the handle (12) is made with a width (18) of 41±5 mm.

9. The crowbar according to claim 8, wherein the width (36) of the sharp edge (34) is larger than the width (18) of the handle (12).

10. The crowbar according to claim 6, wherein the sharp edge (34) is made of a width (36) larger than that of the handle (12).

11. The crowbar according to claim 1, further crowbar comprising a secondary blade (20) extending from another end of the handle (12).
